(19) United States
(12) Patent Application Publication
(10) Pub. No.: US 2002/0060171 A1
(43) Pub. Date: May 23, 2002

(54) Apparatus for allocating passive devices before sintering

(75) Inventor: I-Chang Tsai, Kaohsiung Hsien (TW)

Correspondence Address: DOUGHERTY & TROXELL, Suite 1404, 5205 LEESBURG PIKE, FALLS CHURCH, VA, 22041, US

(73) Assignee: Schmidt Scientific Taiwan Ltd.

(21) Appl. No.: 09/987,972

(22) Filed: Nov. 16, 2001

(30) Foreign Application Priority Data
Nov. 23, 2000 (TW) 89220340

(51) Int. Cl. B07B 1/00

(52) U.S. Cl. 209/235

(57) ABSTRACT

The present invention is directed to an apparatus for allocating passive devices before sintering, which comprises: a preparation area, which includes a frame in which trays located, a first driver and a sliding track; a loading area, which includes a vibrator; an operation area, which includes a loading material portion and a receiving portion; and an output area, which includes a collection frame and a second driver; wherein the vibrator is arranged in a position higher than that of the receiving portion; an oblique plate structure is disposed at the side of the vibrator facing to the receiving portion; a slide plate is set at the bottom surface of the oblique plate structure, thereby forming the loading material portion; a first side frame is formed at both ends of the plate oblique structure and the slide plate; and a first pressing plate is locked on the first side frame, thereby forming a gap between the bottom end of the first pressing plate and the top end of the slide plate. The width of the gap is designed to be 110-200(exclusive) percentage of the scale of the passive device under transported so that the devices can fall into the tray in a single layer with a dense allocation.

### FIELD OF THE INVENTION

The present invention relates to an apparatus for allocating passive devices before sintering, and particularly to an apparatus for densely allocating passive devices on a tray without stacking.

### BACKGROUND OF THE INVENTION

With the rapid advances in the electronic technology industry, designers are always tempted to improve the performance of the passive devices. The well-known passive devices such as capacitors and resistors are cut to small separate particles. During the manufacture, the passive device is loaded in a high temperature environment for sintering to enhance the stiffness thereof and is followed by post processing. Since the volume of the typical passive devices is small, about in millimeters scale, the devices are fed for sintering after the tray is filled with a certain number of the devices.

The passive devices with a small scale are usually loaded on the tray by manpower and this procedure is liable to stack up the devices . Because the surface of the passive device is covered by the other passive device stacked thereon, the covered surface is not sintered . This causes an increase in the number of unsintered particles, which are undesired products and need to be sieved and removed. Thus, it wastes time and resources.

Moreover, separating the stacked passive devices by operators is both labor consuming and time-consuming. In addition, in order to prevent the passive devices from being piled, it avoids loading too many passive devices in the tray; otherwise, it is difficult to allocate those devices by hand to a single layer.

Hence, it is hard to lift up the performance of sintering the passive devices currently, and thus there is a need to improve the above-mentioned situations.

### SUMMARY OF THE INVENTION

It is, therefore, an object of the present invention to provide an apparatus for allocating passive devices on a tray before sintering.

In accordance with the invention, the apparatus for allocating passive devices before sintering comprises a preparation area, which includes a frame in which trays located, a first driver and a sliding track; a loading area, which includes a vibrator; an operation area, which includes a loading material portion and a receiving portion; and an output area, which includes a collection frame and a second driver; wherein the vibrator is arranged in a position higher than that of the receiving portion; an oblique plate structure is disposed at the side of the vibrator facing to the receiving portion; a slide plate is set at the bottom surface of the oblique plate structure, thereby forming the loading material portion; a first side frame is formed at both ends of the plate oblique structure and the slide plate; and a first pressing plate is locked on the first side frame, thereby forming a gap between the bottom end of the first pressing plate and the top end of the slide plate.

The width of the gap is designed to be 110-200(exclusive) percentage of the scale of the passive device so that in the path of falling into the loading material portion through the vibrator, the passive devices can enter into the tray of the receiving portion without being stacking and in a dense single layer allocation.

Therefore, this invention not only overcomes the drawbacks of manpower operation but also enhances the performance of sintering the passive devices.

Moreover, a detector is set at a suitable location of the first pressing plate; a plurality of sucking port sets are disposed at the side of the first pressing plate adjacent to the receiving portion; and a plurality of detector modules corresponding to the sucking port sets are disposed over the receiving portion.

The apparatus for allocating passive devices of the present invention further comprises a plurality of supporting plates used to support the sliding track and the receiving portion, a second side frame formed at both ends of the supporting plate of the receiving portion, and a second pressing plate formed on the supporting plate of the receiving portion and locked on the second side frame. A suitable gap between the bottom end of the second pressing plate and the top end of the supporting plate allows the tray to move therein.

In a further embodiment, a plurality of cassettes are disposed in the collection frame for receiving the trays, and a lateral movement means for moving the collection frame is provided to shift an empty cassette to the front of the receiving portion.

### BRIEF DESCRIPTION OF THE DRAWINGS

The invention itself, however, as well as a preferred mode of use, will best be understood by reference to the following detailed description of an illustrative embodiment when read in conjunction with the accompanying drawings, wherein:

FIG. 1 is a top view according to the present invention;

FIG. 2 is a front view according to the present invention;

FIG. 3 shows a front view according to the present invention after the collecting frame and the lateral movement means are removed;

FIG. 4 is a portion of a cross sectional view according to the present invention;

FIG. 5 is a portion of the top view according to the present invention;

FIG. 6 shows a longitudinal cross sectional view of the loading material portion according to the present invention;

FIG. 7 shows a first working example of the tray movement according to the present invention; and

FIG. 8 shows a second working example of the tray movement according to the present invention.

### DETAILED DESCRIPTION OF THE PREFERRED EMBODIMENT

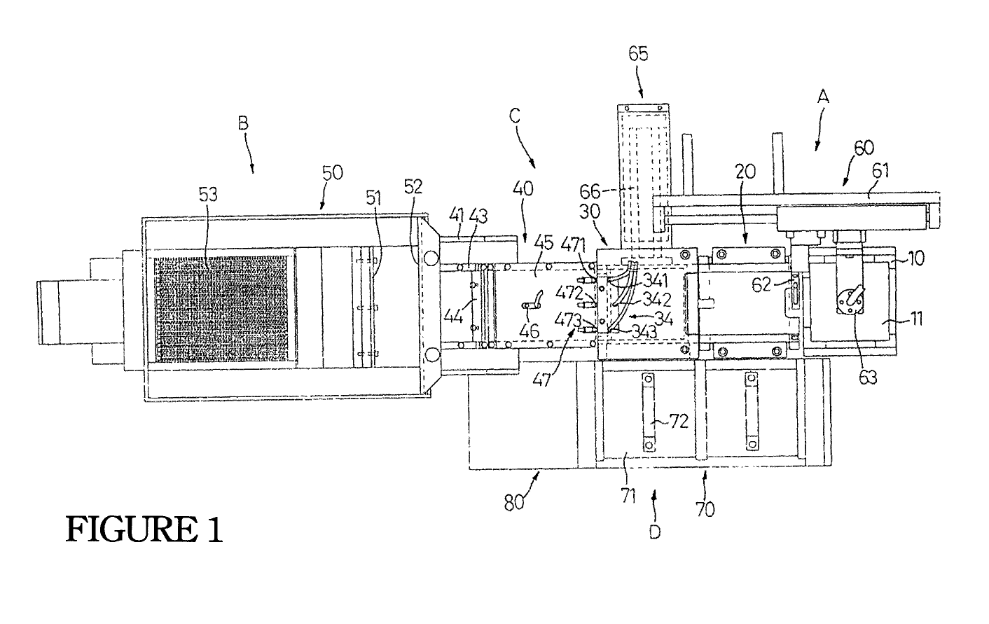

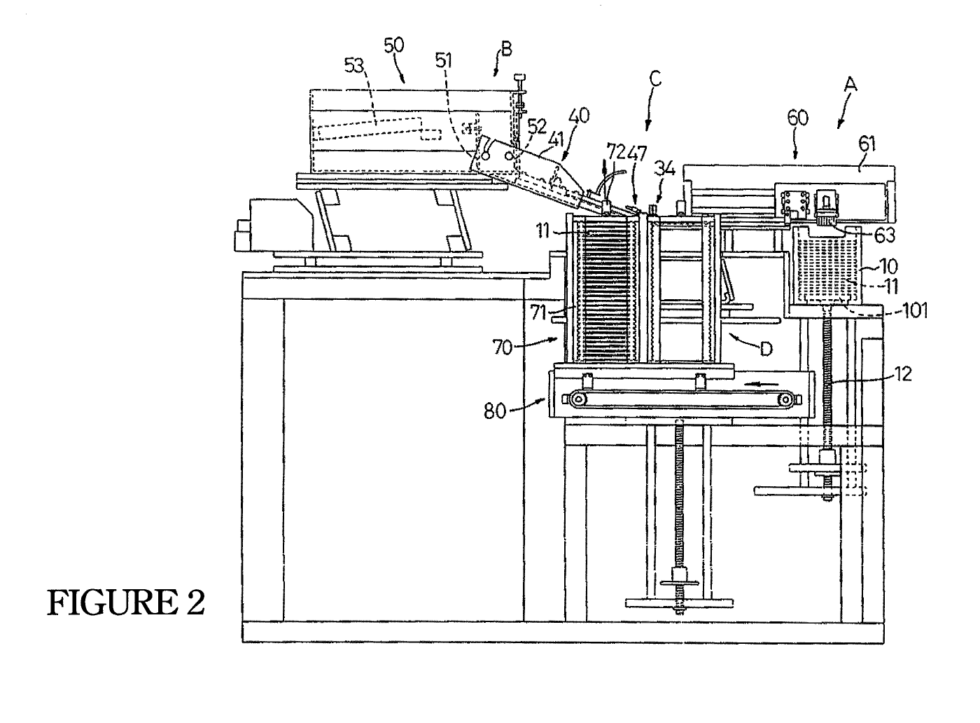

Referring to FIG. 1 in conjunction with FIG. 2, the drawings respectively show the top view and the front view of an apparatus for allocating passive devices according to the present invention. The apparatus for allocating passive devices includes a preparation area A, a loading area B, an operation area C and an output area D. The preparation area A includes a frame 10, a sliding track 20 and a first driver 60. The loading area B includes a vibrator 50, and the operation area C includes a loading material portion 40 and a receiving portion 30. The output area D includes a collection frame 70 and a second driver 65.

Stacked trays 11 are located in the frame 10 of the preparation area A. The tray 11 is transported to the sliding track 20 by the first driver 60 and is pushed into the receiving portion 30 of the operation area C. The passive devices may be transported by the vibrator 50 of the loading area B into the receiving portion 30 through the loading material portion 40 of the operation area C. Then, the tray 11 in the receiving portion 30 loads the transported passive devices. After the tray 11 is filled with the passive devices, the second driver 65 of the output area D drives the tray 11 into a cassette 71 set in the collection frame 70.

The cassette 71 will be fetched out of the collection frame 70 by hand after it is full of a predetermined number of trays.

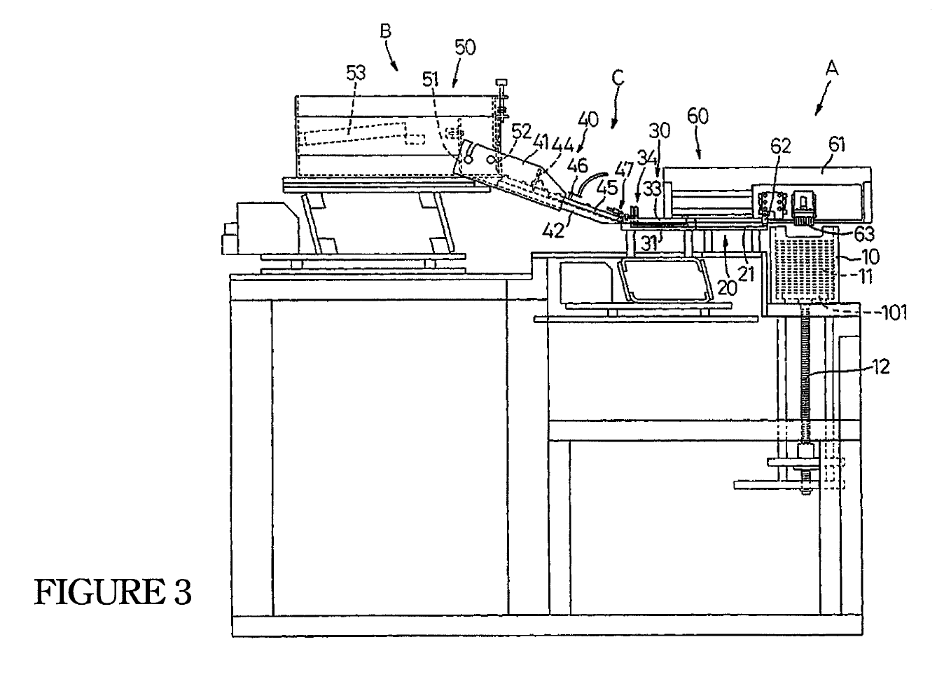

Referring to FIG. 3 and FIG. 1, a lower plate 101 is set in the frame 10 of the preparation area A. A shank 12 with spirals is connected to the bottom of the lower plate 101. A power machine may force the lower plate 101 to move upwardly or downwardly by propelling the rotation of the shank 12, thereby to move the tray 11 upwardly or downwardly. The first driver 60 is disposed on a frame plate 61 and a sucking disc 63 and a pushing rod 62 are suspended on an edge face of the driver 60. The sliding track 20 and the receiving portion 30 are constructed respectively by supporting plates 21, 31 and a pressing plate 33 is set on the supporting plate 31.

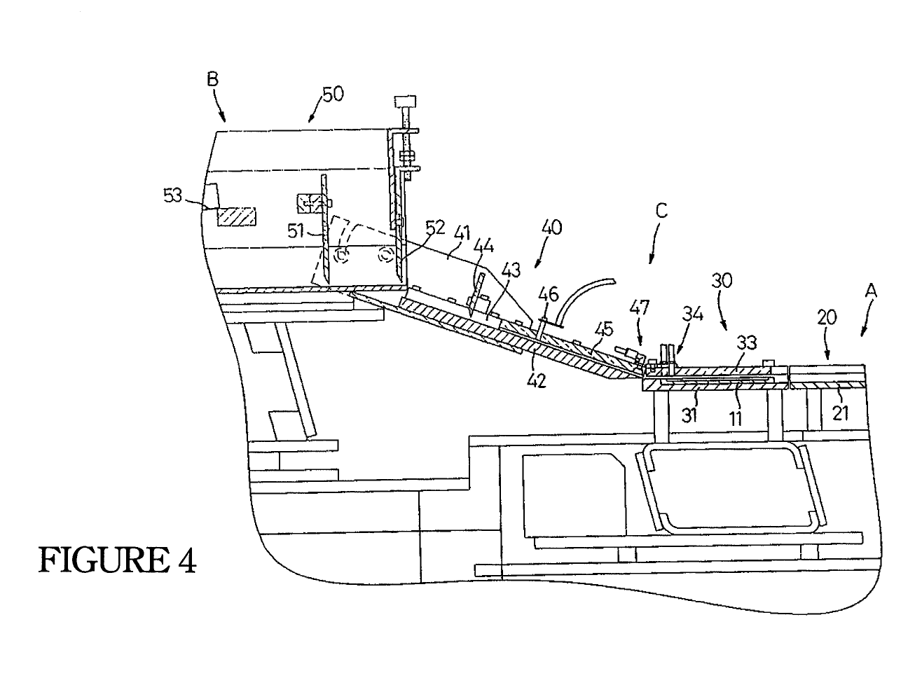

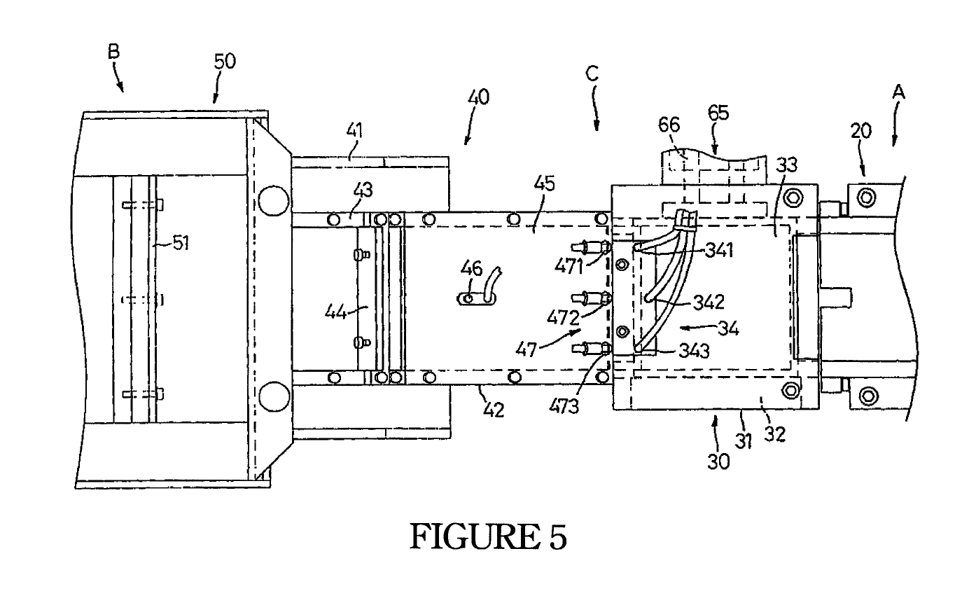

Turning to FIG. 4 and FIG. 5, a side frame 32 is set at the front end and the rear end of the supporting plate 31 of the receiving portion 30 in the operation area C. The front end and the rear end of the transparent pressing plate 33 can be locked upon the side frame 32. A suitable gap between the bottom end of the pressing plate 33 and the top end of the supporting plate 31 allows the tray 11 to move therein.

Further, the rear side frame 32 of the pressing plate 33 has an opening which allows a pushing rod 66 of the second driver 65 to extend into the gap between the pressing plate 33 and the supporting plate 31.

In addition, a detector module 34 is set at the side of the pressing plate 33 near the loading material portion 40. The detector module 34 includes a first detector 341, a second detector 342 and a third detector 343. The number of the detectors required may depend on the actual practice.

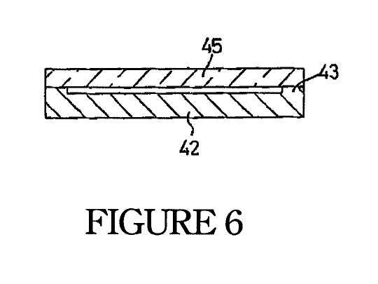

As shown in FIGS. 4 and 5, the side portion of the receiving portion 30 in the operation area C is connected to the loading material portion 40 which is set in front of the vibrator 50 of the loading area B. The vibrator 50 is arranged in a position higher than that of the receiving portion 30. An oblique plate structure 41 is disposed at the side of the vibrator 50 facing to the receiving portion 30. A slide plate 42 is set at the bottom surface of the oblique plate structure 41, thereby forming the loading material portion 40. A side frame 43 is set at the front end and the rear end of the plate structure 41 and the slide plate 42. The front end and the rear end of a transparent pressing plate 45 can be locked upon the side frame 43 and a gap is formed between the bottom end of the pressing plate 45 and the top end of the slide plate 42, as shown in FIG. 6.

Preferably, the width of the gap is about 110-200(exclusive) percentage of the scale of the passive device. For example, if the scale of the device is about 1 mm, the width of the gap between the bottom end of the pressing plate 45 and the top end of the slide plate 42 is about 1.1 mm to less than 2 mm. Thus, each of the passive devices may slide through the gap smoothly and will not be stacked up.

Further, a detector 46 is set at a suitable location of the pressing plate 45, and a sucking port set 47 is set at the side of the pressing plate 45 near the receiving portion 30. The sucking port set 47 includes a first sucking port 471, a second sucking port 472 and a third sucking port 473. The number of the sucking ports required may depend on the actual practice. A sifting disc 53, a first stopper 51 and a second stopper 52 may be set in the vibrator 50. A third stopper 44 may be set on the slide plate 42 of the loading material portion 40 away from the pressing plate 45.

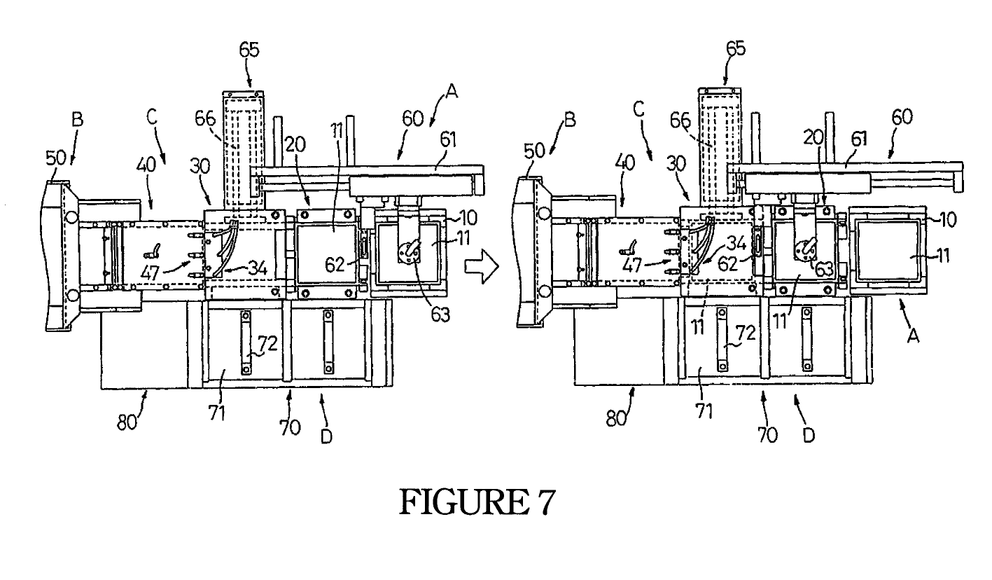

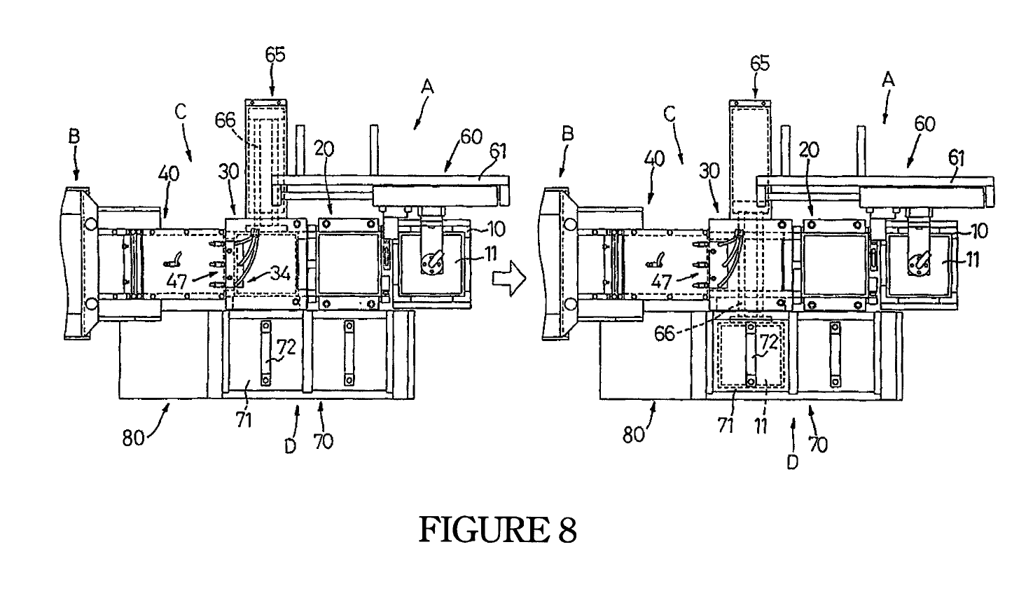

Turning to FIGS. 7-8, the tray 11 is automatically loaded through sucking by the sucking disc 63 suspended on the first driver 60 and laterally moving the sucked tray 11 by the driver 60 into the sliding track 20. Then, the driver 60 returns and repeats the previous process to load another tray 11. The former tray 11 is transported to the receiving portion 30 by the pushing rod 62 and the second tray 11 stands by in the sliding track 20. Subsequently, the vibrator 50 is started to laterally transport the passive devices by the vibration thereof into the tray 11 loaded in the receiving portion 30 via the loading material portion 40. The tray 11 will not be fetched out until the tray 11 is filled with the devices.

Referring to FIG. 8, the second driver 65 is then started to force the pushing rod 66 to forwardly push the filled tray 11 in the receiving portion 30 into the cassette 71 in the collection frame 70. Subsequently, the sucking disc 63 on the frame plate 61 may suck another tray 11 and activates the frame plate 61 to laterally move and to force the tray 11 exiting in the track 20 into the receiving portion 30, and then the sucked tray is located in the track 20 to stand by. As a result, another circulation is formed.

To achieve the dense allocation of the passive devices into the tray 11, the sifting disc 53 of the vibrator 50 proceeds the first procedure of filtering out the passive devices with an unqualified scale. The qualified devices are allowed to enter into the vibrator 50, and with the vibration of the vibrator 50, the passive devices move towards to the loading material portion 40.

In this path, the stacked passive devices are swept by the first stopper 51 and the second stopper 52. Then, the devices slide downwardly through the third stopper 44 in the loading material portion 40 into the gap between the pressing plate 45 and the slide plate 42, thereby transported into the tray 11 in the receiving portion 30.

Further, another vibrator (not shown) is employed to vibrate the receiving portion 30 with a vibrating frequency that is higher than that of the vibrator 50. Thus, the passive devices which slide down from the loading material portion 40 can be further vibrated to have the result of a dense allocation while falling into the tray 11.

The first detector 341, the second detector 342 and the third detector 343 of the detector module 34 can monitor helloing of the passive devices where the respective detector is located, in combination with the co-operated corresponding sucking ports 471, 472 and 473 of the sucking port set 47.

When the passive devices are transported through the loading material portion 40 into the receiving portion 30, if the tray 11 is partially filled with the passive devices, for example, the regions corresponding to the first detector 341 and the third detector 343 are detected to be filled up with the devices, the first sucking port 471 and the third sucking port 473 will then be activated to suck the subsequent passive devices which fall into those regions. And now only the devices which fall into the central region corresponding to the second detector 342 (see FIG. 5) can continue loading until the central region of the tray 11 is also filled up. Then, the second sucking port 472 is activated to suck the subsequent falling devices. At this time, all of the falling passive devices are stopped by the absorption of the sucking ports, and then the tray 11 in the receiving portion 30 is pushed into the collection frame 70.

Another tray 11 is loaded into the receiving portion 30, and the sucking function of the sucking ports is then released, and thus the next circulation of loading material operation continues. That is, the sucking port module 47 acts as a vacuumed gate to control the flowing rate of the passive devices.

Moreover, during the loading process of the passive devices, if the falling rate of the passive devices resulted from the vibration of the vibrator 50 is so high that the devices are piled upwardly to the level of the detector 46 in the loading material portion 40, the detector 46 will detect this situation and activate a microcontroller to slow down the vibration frequency of the vibrator 50, thereby reducing the falling rate of the devices so as to allow the passive devices to more smoothly fall into the tray 11 with a dense allocation.

Further, two sets of cassettes 71 can be disposed at both sides of the collection frame 70. When, one set of the cassettes 71 is full of the trays 11, an additional sensor will detect the situation and then drive a lateral movement means 80 to move laterally so as to shift the other set cassette 71 in front of the receiving portion 30 to stand by. As shown in FIG. 2, the cassette 71 full of the trays 11 can be fetched out upwardly with a handle 72.

As is understood by a person skilled in the art, the foregoing preferred embodiment of the present invention is illustrative, not for purposes of limitation. It is intended to cover various modifications and similar arrangements included within the spirit and scope of the appended claims, the scope of which should be accorded the broadest interpretation so as to encompass all such modifications and similar structures.

I claim:

1. An apparatus for allocating passive devices before sintering comprising:
a preparation area, which includes a frame in which trays located, a first driver and a sliding track;
a loading area, which includes a vibrator;
an operation area, which includes a loading material portion and a receiving portion; and
an output area, which includes a collection frame and a second driver;
wherein said vibrator is arranged in a position higher than that of said receiving portion; an oblique plate structure is disposed at the side of said vibrator facing to said receiving portion; a slide plate is set at the bottom surface of said oblique plate structure, thereby forming said loading material portion; a first side frame is formed at both ends of said plate oblique structure and said slide plate; a first pressing plate is locked on said first side frame, thereby forming a gap between the bottom end of said first pressing plate and the top end of said slide plate; a detector is set at a suitable location of said first pressing plate; a plurality of sucking port sets are disposed at the side of said first pressing plate adjacent to said receiving portion; and a plurality of detector modules corresponding to said sucking port sets are disposed over said receiving portion.

2. The apparatus for allocating passive devices before sintering of claim 1, wherein the width of said gap is approximately 110-200(exclusive) percentage of the scale of said passive device under transported.

3. The apparatus for allocating passive devices before sintering of claim 1, wherein said vibrator includes a sifting disc, a first stopper and a second stopper.

4. The apparatus for allocating passive devices before sintering of claim 3, wherein said vibrator further includes a third stopper set on said slide plate of said loading material portion away from said first pressing plate.

5. The apparatus for allocating passive devices before sintering of claim 1, wherein said preparation area includes a pushing rod and a sucking disc suspended on said first driver, said sucking disc sucking said tray in said frame and said first driver moving laterally so as to allow said tray to be put in said sliding track and to be push into said receiving portion.

6. The apparatus for allocating passive devices before sintering of claim 1, further compris comprising a plurality of supporting plates used to support said sliding track and said receiving portion, a second side frame formed at both ends of said supporting plate of said receiving portion, and a second pressing plate formed on said supporting plate of said receiving portion and locked on said second side frame wherein a suitable gap between the bottom end of said second pressing plate and the top end of said supporting plate allows said tray to move therein.

7. The apparatus for allocating passive devices before sintering of claim 1, further compris comprising a plurality of cassettes disposed in said collection frame for receiving said trays, and a lateral movement means for moving said collection frame so as to shift an empty cassette to the front of said receiving portion.
